(19) United States
(12) Patent Application Publication
(10) Pub. No.: US 2025/0322313 A1
(43) Pub. Date: Oct. 16, 2025

(54) ELECTRONIC DEVICE FOR PERFORMING DISTRIBUTED TRAINING IN HETEROGENEOUS COMPUTING ENVIRONMENT, AND CONTROL METHOD THEREOF

(71) Applicant: SAMSUNG ELECTRONICS CO., LTD., Suwon-si (KR)

(72) Inventors: Taejeoung KIM, Suwon-si (KR); Hyun CHOI, Suwon-si (KR)

(73) Assignee: SAMSUNG ELECTRONICS CO., LTD., Suwon-si (KR)

(21) Appl. No.: 19/253,014

(22) Filed: Jun. 27, 2025

Related U.S. Application Data
(63) Continuation of application No. PCT/KR2024/003317, filed on Mar. 15, 2024.

(30) Foreign Application Priority Data
Apr. 12, 2023 (KR) 10-2023-0048272
Oct. 17, 2023 (KR) 10-2023-0138604

(51) Int. Cl. G06N 20/00

(52) U.S. Cl. CPC G06N 20/00

(57) ABSTRACT

An electronic device performing distributed training of an artificial intelligence (AI) model in a heterogeneous computing environment includes a communication interface for communicating with multiple computation nodes; a memory storing profile information on the multiple computation nodes and instructions; and at least one processor configured to assign weights to each of the multiple computation nodes for segmenting the AI model and training data based on the profile information; distribute the segmented AI model and training data to the multiple computation nodes based on the assigned weights; control the multiple computation nodes to train the segmented AI model; convert training result data from a first computation node into a data format processible by other computation nodes; and control a second computation node to train the segmented AI model based on the converted data.

### CROSS-REFERENCE TO RELATED APPLICATION

This application is a by-pass continuation application of International Application No. PCT/KR2024/003317, filed on Mar. 15, 2024, which is based on and claims priority to Korean Patent Application No. 10-2023-0048272, filed on Apr. 12, 2023, and Korean Patent Application No. 10-2023-0138604, filed on Oct. 17, 2023 in the Korean Intellectual Property Office, the disclosures of which are incorporated by reference herein in their entireties.

### 1. FIELD

This disclosure relates to an electronic device and a control method for performing distributed training in a heterogeneous computing environment.

### 2. DESCRIPTION OF RELATED ART

In recent years, for a provision of higher-level of services, it is important to smoothly train a large-scale deep learning model with massive data. There may be a problem that the above-described deep learning model training is too complex to be smoothly performed and requires long computation time.

To solve the problem, parallelizing the training of a deep learning model having high complexity in a high-performance computing environment is suggested as the most promising solution. In the high-performance computing environment, a computation node equipped with a computing device such as a graphics processing unit (GPU) and a neural processing unit (NPU) is provided in a cluster form, rather than a normal server comprised an existing central processing unit (CPU). Herein, a data parallel processing method is adopted mainly in the way that a model trained by distributing an artificial intelligence model and data to each computing device is integrated. Such parallelization may still suffer from synchronization overhead and resource imbalance, depending on the capabilities of each node.

As a method of training an AI model, distributed training is used in which an AI model is trained through distributed computing by using a computer cluster. In the case where distributed training is performed by using a computer cluster, a master node of the computer cluster may train an AI model by collecting training results from each node. A delay in acquisition of results of processed computation from part of nodes included in the computer cluster due to a difference in computing performance or a difference in a network speed and the like of the nodes included in the cluster may result in a delay in an entire distributed training process.

### SUMMARY

According to an aspect of the disclosure, an electronic device performing distributed training of an artificial intelligence (AI) model in a heterogeneous computing environment includes a communication interface configured to perform communication with multiple computation nodes; a memory configured to store profile information on the multiple computation nodes and at least one instruction; and at least one processor configured to execute the at least one instruction to assign a weight to each of the multiple computation nodes for segmenting the AI model and training data, based on the profile information; distribute the segmented AI model and the segmented training data to the multiple computation nodes based on the assigned weight; control the multiple computation nodes to train the segmented AI model based on the segmented training data; convert training result data received from a first computation node among the multiple computation nodes into a data format processible by each of the multiple computation nodes; and control a second computation node among the multiple computation nodes to train the segmented AI model based on the converted data.

The electronic device may include wherein the at least one processor is further configured to execute the at least one instruction to convert the training result data received from the first computation node into a predefined data format, and convert the predefined data format into the data format processible by the second computation node.

The electronic device may include wherein the profile information includes performance information and network speed information of the multiple computation nodes, and wherein the at least one processor is further configured to execute the at least one instruction to assign a weight for distributing the segmented AI model and the segmented training data to each of the multiple computation nodes, based on the performance information and the network speed information.

The electronic device may include wherein the at least one processor is further configured to execute the at least one instruction to distribute the segmented AI model and the segmented training data to the multiple computation nodes, based on a ratio of a weight assigned to each of the multiple computation nodes to a total of weights assigned to the multiple computation nodes.

The electronic device may include wherein the at least one processor is further configured to execute the at least one instruction to, based on a size of the segmented AI model and segmented training data, that are distributed to at least one computation node among the multiple computation nodes, exceeding memory capacity of the at least one computation node, redistribute at least a portion of the segmented AI model and the segmented training data that are distributed to the at least one computation node to one or more other computation nodes among the multiple computation nodes based on the memory capacity of the at least one computation node.

The electronic device may include wherein the at least one processor is further configured to execute the at least one instruction to identify a computation time taken for each of the multiple computation nodes to train the segmented AI model, and adjust sizes of the segmented AI model and the segmented training data that are distributed, based on the computation time.

The electronic device may include wherein the at least one processor is further configured to execute the at least one instruction to acquire a user input for selecting a computation node for performing the distributed training among the multiple computation nodes, and perform distributed training of the AI model based on the selected computation node.

The electronic device may include wherein the at least one processor is further configured to execute the at least one instruction to identify training performance time of the multiple computation nodes, identify a computation node having the training performance time greater than or equal to a threshold value among the multiple computation nodes, and reduce the segmented training data that is distributed to the computation node.

According to another aspect of the disclosure, a control method of an electronic device performing distributed training of an artificial intelligence (AI) model in a heterogeneous computing environment includes assigning a weight to each of multiple computation nodes for segmenting the AI model and training data, based on profile information of each of the multiple computation nodes; distributing the segmented AI model and the segmented training data to the multiple computation nodes based on the assigned weight; controlling the multiple computation nodes to train the segmented AI model based on the segmented training data; converting training result data received from a first computation node among the multiple computation nodes into a data format processible by each of the multiple computation nodes; and controlling a second computation node among the multiple computation nodes to train the segmented AI model based on the converted data.

The control method may include further comprising converting the training result data received from the first computation node into a predefined data format, and converting the predefined data format into the data format processible by the second computation node.

The control method may include wherein the profile information includes performance information and network speed information of the multiple computation nodes, and wherein the assigning a weight comprises assigning a weight for distributing the segmented AI model and the segmented training data to each of the multiple computation nodes, based on the performance information and the network speed information.

The control method may include wherein the distributing the segmented AI model and the segmented training data to the multiple computation nodes comprises distributing the segmented AI model and the segmented training data to the multiple computation nodes, based on a ratio of a weight assigned to each of the multiple computation nodes to a total of weights assigned to the multiple computation nodes.

The control method may include wherein the distributing the segmented AI model and the segmented training data to the multiple computation nodes comprises, based on a size of the segmented AI model and segmented training data, that are distributed to at least one computation node among the multiple computation nodes, exceeding memory capacity of the at least one computation node, redistributing at least a portion of the segmented AI model and the segmented training data that are distributed to the at least one computation node to one or more other computation nodes among the multiple computation nodes based on the memory capacity of the at least one computation node.

The control method may include further comprising identifying a computation time taken for each of the multiple computation nodes to train the segmented AI model, and adjusting sizes of the segmented AI model and the segmented training data that are distributed, based on the computation time.

The control method may include further comprising acquiring a user input for selecting a computation node for performing the distributed training among the multiple computation nodes, and performing distributed training of the AI model based on the selected computation node.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a view provided to explain a distributed training system according to one or more embodiments;

FIG. 2A and FIG. 2B are block diagrams provided to explain a configuration of an electronic device according to one or more embodiments;

FIG. 3 is a view provided to explain a method of segmenting data to computation nodes by an electronic device according to one or more embodiments;

FIG. 4 is a view provided to explain profile information of a computing device according to one or more embodiments;

FIG. 5 and FIG. 6 are views provided to explain a method of assisting with data transmission and reception between computation nodes by an electronic device according to one or more embodiments; and

FIG. 7 is a view provided to explain a method of providing a UI setting a computation node according to one or more embodiments.

### DETAILED DESCRIPTION

Embodiments of the present disclosure may be modified in various different forms, and may vary. Accordingly, some embodiments are illustrated in the drawings, and described in detail in the detailed description. It is to be understood that the scope of the disclosure is not limited to some embodiments, but embodiments are to be interpreted as including various modifications, equivalents and/or alternatives of the embodiments set forth herein. In the drawings, like reference numerals may be used to indicate like elements.

The embodiments described in the disclosure, and the configurations shown in the drawings, are only examples of embodiments, and various modifications may be made without departing from the scope and spirit of the disclosure.

In describing the disclosure, in case some descriptions of known functions or configurations to which the disclosure pertains make the gist of the disclosure unnecessarily vague, detailed descriptions thereof are omitted.

Additionally, the embodiments described hereinafter may be modified in various different forms, and it is to be understood that the scope of the technical spirit of the disclosure is not limited to the embodiments. Rather, the embodiments are provided to make the disclosure thorough and complete and to fully convey the technical spirit of the disclosure to those skilled in the art.

Terms set forth herein are merely used to describe a specific embodiment, and are not intended to limit the scope of the right that seeks protection. Unless explicitly stated otherwise, singular forms include plural forms as well.

In the disclosure, expressions such as “have,” “may have,” “include,” or “may include,” and the like are used to indicate the presence of a corresponding feature (e.g., elements such as a numerical value, a function, an operation, or a component and the like), and do not imply exclusion of the presence of additional features.

In the disclosure, expressions such as “A or B,” “at least one of A or/and B,” or “one or more of A or/and B” may include all possible combinations of items listed together. For example, “A or B,” “at least one of A and B,” or “at least one of A or B” may refer to all cases including (1) at least one A, (2) at least one B, or (3) both of at least one A and at least one B.

In the disclosure, the expression “1st”, “2nd”, “first”, or “second”, and the like may be used to refer to various elements regardless of their order and/or importance, and may be used merely to differentiate one element from another but not intended to limit the elements.

Based on one element (e.g., a first element) referred to as being “(operatively or communicatively) coupled with/to or connected with/to” another element (e.g., a second element), it is to be understood that one element may be connected to another element directly or through yet another element (e.g., a third element).

On the other hand, based on one element (e.g., a first element) referred to as being “directly coupled with/to” or “directly connected with/to” another element (e.g., a second element), it is to be understood that yet another element (e.g., a third element) is not present between one element and another element.

In the disclosure, the expression “configured to . . . (or set to)” used in the disclosure may be used interchangeably with, for example, “suitable for . . . ,” “having the capacity to . . . ,” “designed to . . . ,” “adapted to . . . ,” “made to . . . ,” or “capable of . . . ” depending on circumstances. The term “configured to . . . (or set to)” may not necessarily mean “specifically designed to . . . ” in terms of hardware.

Rather, in a certain situation, the expression “a device configured to . . . ” may mean “being capable of performing” by the device together with another device or other components. For example, the phrase “a processor configured (or set) to perform A, B and C” may mean an exclusive processor (e.g., an embedded processor) for performing the functions, or a generic-purpose processor (e.g., a CPU or an application processor) capable of performing the functions by executing one or more software programs stored in a memory device.

In relation to the embodiments, the term “module” or “unit” may perform at least one function or operation, and be implemented by hardware or software or by a combination of hardware and software. Additionally, multiple “modules” or multiple “units” may be integrated into at least one module and be implemented as at least one processor except for a “module” or a “unit” that needs to be implemented by a hardware.

Meanwhile, various elements and regions in the drawings are schematically illustrated. Accordingly, the technical spirit of the disclosure is not limited by relative sizes or distances illustrated in the accompanying drawings.

Hereinafter, embodiments according to the disclosure are described specifically with reference to the accompanying drawings such that those skilled in the art to which the disclosure pertains may readily implement the embodiments.

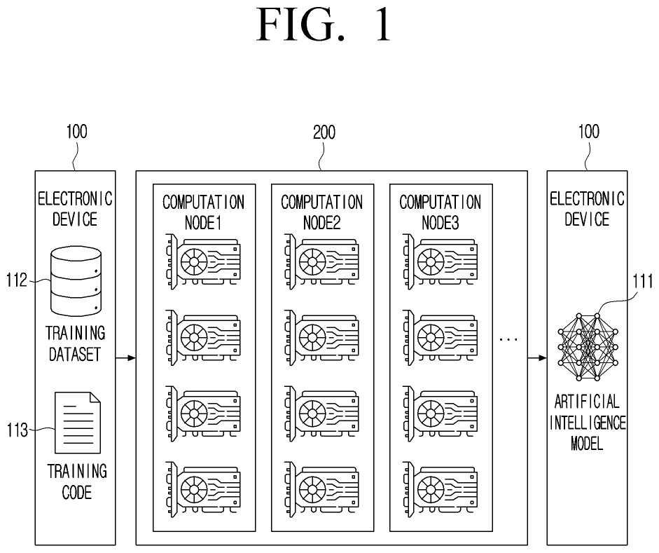

FIG. 1 is a view provided to explain a distributed training system according to one or more embodiments.

An electronic device 100 may store a training dataset 112 and a training code 113 for performing distributed training. Herein, the training dataset 112 and the training code 113 may be data for training an artificial intelligence model.

Additionally, the electronic device 100 may perform distributed training of an AI model 111 that is trained through data parallelism by using multiple computation nodes 200.

The computation nodes may include at least one computing device (e.g., an accelerator) for providing computational resources. The computing device may be a device for performing training and inference of an AI model. For example, the computing device may include one or more of a GPU, a CPU, an APU, a MIC, a DSP, an NPU, an MPU, a hardware computing device or a machine learning computing device.

At this time, one computation node may include a homogeneous computing device. Additionally, the multiple computation nodes may include computing devices that are heterogeneous from each other. For example, a first computation node may include at least one first computing device. A second computation node may include at least one second computing device. Furthermore, a third computation node may include at least one third computing device. At this time, the types of the first computing device, the second computing device and the third computing device may differ. Computation speeds of the first computing device, the second computing device and the third computing device may differ. Alternatively, memory capacity of the first computing device, the second computing device and the third computing device may differ. Alternatively, a communication speed between the first computing device, the second computing device and the third computing device, and the electronic device 100 may differ. The electronic device 100 may segment the training dataset 112 and distribute the same to each of the multiple computation nodes.

Additionally, the electronic device 100 may perform distributed training of the AI model 111, by using the training dataset 112 distributed to each of the multiple computation nodes.

That is, as for the electronic device 100, each of the multiple computation nodes may control the multiple computation nodes by using the training dataset 112 distributed to each of the multiple computation nodes. Additionally, the electronic device 100 may receive results of performance of training from the multiple computation nodes, and train the AI model 111 by collecting the received results.

Additionally, though not illustrated in the drawings, the electronic device 100 according to one or more embodiments may perform distributed inference of the AI model through model parallelism and data parallelism by using the multiple computation nodes.

That is, the electronic device 100 may segment the AI model 111 of which training is not completed and the training dataset 112, and distribute the same to each of the multiple computation nodes.

The electronic device 100 may perform distributed training of the AI model 111, by using the AI model 111 and the training dataset 112 distributed to each of the multiple computation nodes.

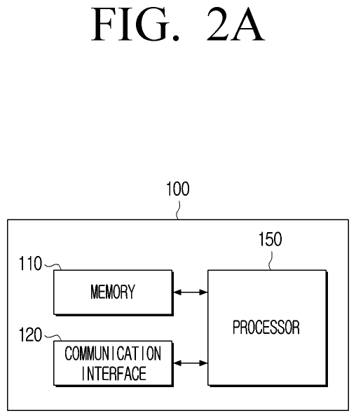

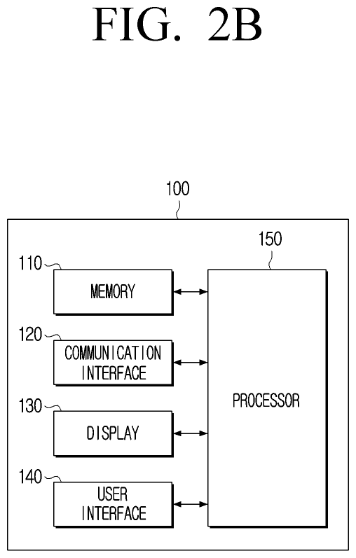

FIG. 2A and FIG. 2B are block diagrams provided to explain a configuration of an electronic device according to one or more embodiments. Referring to FIG. 2A, an electronic device 100 may include a memory 110, a communication interface 120 and a processor 150. As for the electronic device 100, some of the above-described elements may be omitted, and another element may be further included. At this time, multiple computing devices may be included in the electronic device 100, but this is merely one example, and the multiple computing devices may be implemented as a separate device apart from the electronic device 100.

Additionally, the electronic device 100 may be implemented as a server, but not limited thereto.

The memory 110 may store at least one instruction associated with the electronic device 100. The memory 110 may store an operating system (O/S) for driving the electronic device 100. Additionally, the memory 110 may store various types of software programs or applications for the electronic device 100 to operate according to various embodiments of the disclosure. The memory 110 may include semiconductor memory such as flash memory and the like, or a magnetic storage medium such as a hard disk and the like, and the like.

The memory 110 may store various types of software modules for the electronic device 100 to operate according to various embodiments of the disclosure, and the processor 150 may control operations of the electronic device 100 by executing various types of software modules stored in the memory 110. That is, the memory 110 may be accessed by the processor 150, and reading/recording/correcting/deleting/updating and the like of data in the memory 110 may be performed by the processor 150.

Meanwhile, in the disclosure, the term memory 110 may be used in the way that the term memory 110 has a meaning including a memory 110, ROM (not illustrated) or RAM (not illustrated) in the processor 150, or a memory card (not illustrated; e.g., a micro SD card, a memory stick) mounted in the electronic device 100.

The memory 110 may store an AI model 111 for performing distributed training or distributed inference. At this time, the memory 110 may store training dataset 112 for training the AI model 111. Additionally, the memory 110 may store input data for performing inference of the AI model 111.

The communication interface 120 includes circuitry, and is an element communicable with an external apparatus and a server. The communication interface 120 may perform communication with an external apparatus or a server based on a wired or wireless communication method. The communication interface 120 may include a Bluetooth module (not illustrated), a Wi-Fi module (not illustrated), an infrared (IR) module, a local area network (LAN) module, an Ethernet module and the like. Herein, each of the communication modules may be implemented in the form of at least one hardware chip. A wireless communication module may include at least one communication chip such as Zigbee, Universal Serial Bus (USB), Mobile Industry Processor Interface Camera Serial Interface (MIPI CSI), 3rd Generation (3G), 3rd Generation Partnership Project (3GPP), Long Term Evolution (LTE), LTE Advanced (LTE-A), 4th Generation (4G), 5th Generation (5G) and the like that perform communication according to various wireless communication standards in addition to the above-described communication methods. These are described merely as examples, and the communication interface 120 may use at least one of various types of communication modules.

The communication interface 120 may be connected to multiple computing devices constituting multiple computation nodes. Through the communication interface 120, at least one of an AI model, training data and input data for performing distributed training or distributed inference may be transmitted to each of the multiple computation nodes.

The processor 150 may control entire operations and functions of the electronic device 100. The processor 150 may be connected to the configuration of the electronic device 100 including the memory 110, and may control entire operations of the electronic device 100, by executing at least one instruction stored in the memory 110 as described above.

The processor 150 may be implemented in various ways. For example, the processor 150 may be implemented as at least one of an application specific integrated circuit (ASIC), a logic integrated circuit, an embedded processor, a Micom, a microprocessor, hardware control logic, a hardware finite state machine (FSM), and a digital signal processor (DSP).

The processor 150 may include one or more processors. The one or more processors may include one or more of a central processing unit (CPU), a graphics processing unit (GPU), an accelerated processing unit (APU), Many Integrated Core (MIC), a digital signal processor (DSP), a neural processing unit (NPU), a main processing unit (MPU), a hardware computing device or a machine learning computing device. The one or more processors may control one among other elements of the electronic device or any combination thereof, and perform an operation associated with communication or data processing. The one or more processors may execute one or more programs or instructions stored in the memory. For example, the one or more processors may perform a method according to one embodiment, by executing one or more instructions stored in the memory.

In the case where the method according to one or more embodiments of the disclosure includes multiple operations, the multiple operations may be performed by one processor, or by multiple processors. That is, when a first operation, a second operation, and a third operation are performed based on the method according to one or more embodiments, the first operation, the second operation and the third operation may all be performed by a first processor, or the first operation and the second operation may be performed by the first processor (e.g., a generic-purpose processor), while the third operation may be performed by a second processor (e.g., an AI-exclusive processor).

The one or more processors may be implemented as a single core processor including one core, or one or more multicore processors including multiple cores (e.g., a homogeneous multi core or a heterogeneous multi core). In the case where the one or more processors are implemented as a multicore processor, each of the multiple cores included in the multicore processor may include processor internal memory such as cache memory, and on-chip memory, and common cache shared by the multiple cores may be included in the multicore processor. Additionally, each of the multiple cores (or part of the multiple cores) included in the multicore processor may read and perform a program instruction for implementing the method according to one or more embodiments of the disclosure independently, or in the way that all (or part) of the multiple cores are associated.

In the case where the method according to one or more embodiments of the disclosure includes multiple operations, the multiple operations may be performed by one of the multiple cores included in the multicore processor, or by the multiple cores included in the multicore processor. For example, when a first operation, a second operation, and a third operation are performed based on the method according to one or more embodiments, the first operation, the second operation and the third operation may all be performed by a first core included in the multicore processor, or the first operation and the second operation may be performed by the first core included in the multicore processor, while the third operation may be performed by a second core included in the multicore processor.

In the embodiments of the disclosure, the processor 150 may be a system on a chip (SoC) where one or more processors and other electronic components are integrated, a single core processor, a multicore processor, or a core included in a single core processor or a multicore processor, and herein, the core may be implemented as a CPU, a GPU, an APU, an MIC, a DSP, an NPU, a hardware computing device, or a machine learning computing device and the like, but the embodiment thereof may not be limited thereto.

Operations of the processor 150 for implementing various embodiment of the disclosure may be implemented through multiple modules.

Specifically, data of multiple modules according to the disclosure may be stored in the memory 110, and the processor 150 may access the memory 110 and load the data of multiple modules to a memory or a buffer in the processor 150, and then implement various embodiments of the disclosure by using the multiple modules.

At least one of the multiple modules according to the disclosure may be implemented as hardware, and in the form of a system on a chip (system on chip or SoC), included in the processor 150.

Alternatively, at least one of the multiple modules according to the disclosure may be implemented as a separate external apparatus, and the electronic device 100 and each module may perform operations according to the disclosure while performing communication.

Meanwhile, referring to FIG. 2B, an electronic device 100 according to one or more embodiments may include a memory 110, a communication interface 120, a display 130, a user interface 140 and a processor 150.

The memory 110, the communication interface 120, and the processor 150 are described above with reference to FIG. 2A, and accordingly, repetitive description is avoided.

The display 130 may be implemented as various types of displays such as a liquid crystal display (LCD), an organic light emitting diode (OLED) display, a plasma display panel (PDP) and the like. In the display 130, driving circuitry that may be implemented in the form of an amorphous silicon thin film transistor (a-si TFT), a low temperature poly silicon (LTPS) TFT, an organic TFT (OTFT) and the like, a backlight unit and the like may be included together. Meanwhile, the display 130 may be implemented as a touch screen coupled with a touch sensor, a flexible display, a three-dimensional display (3D display) and the like. Additionally, the display 130 according to one embodiment may include a bezel housing a display panel as well as a display panel outputting an image. The bezel according to one embodiment may include a touch sensor (not illustrated) for sensing a user interaction.

The user interface 140 may be implemented as a device such as a button, a touch pad, a mouse and a keyboard, or a touch screen that can perform the above-described display function and manipulation input function together. Herein, the button may be various types of buttons such as a mechanical button, a touch pad, a wheel and the like that are formed in any area such as a front, a side, a rear and the like of the exterior of the main body of the electronic device 100.

Hereinafter, operations of the processor 150 according to the disclosure are specifically described with reference to the accompanying drawings.

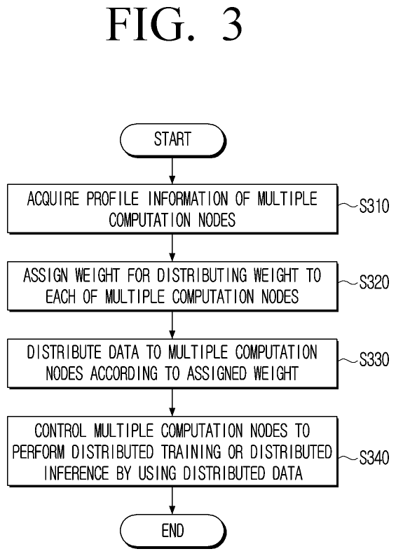

FIG. 3 is a view provided to explain a method of segmenting data to computation nodes by an electronic device according to one or more embodiments.

Referring to FIG. 3, the processor 150 may acquire profile information of multiple computation nodes (S310). The processor 150 may acquire profile information of multiple computing devices constituting the multiple computation nodes.

That is, profile information of each of the multiple computation nodes may be profile information of the multiple computing devices constituting each of the multiple computation nodes. At this time, the multiple computing devices constituting the multiple computation nodes may be a computing device connected to the electronic device 100 through the communication interface 120.

For example, profile information of a first computation node may be profile information of a first computing device constituting the first computation node. Additionally, profile information of a second computation node may be profile information of a second computing device constituting the second computation node.

The memory 110 may store the profile information of each of the multiple computing devices. Additionally, the processor 150 may load the profile information of each of the multiple computing devices, stored in the memory 110. Alternatively, the processor 150 may request the profile information to the multiple computing devices, and receive the profile information of the multiple computing devices from the multiple computing devices.

Profile information of a computing device may include information on properties and performance of the computing device. The profile information of a computing device may include at least one of identification information of a computing device (e.g., a model name of a computing device), manufacturer information of a computing device, computation speed information of a computing device, network speed information of a computing device, memory capacity information of a computing device, memory bandwidth information of a computing device, a training method of a computing device, and a data format processible by a computing device.

The identification information of a computing device may include at least one of a name, a model name and a unique number of a computing device.

The computation speed information of a computing device may be a computation speed of a computing device based on a type of computation data. Herein, the type of computation data may be a floating point of computation data.

For example, the type of computation data may be FP16, FP32 or FP64. FP16 may be a floating point format in which a normalized floating-point number is represented by a sign bit, 5 exponent bits, and 10 significant figure bits. FP32 may be a floating point format in which a normalized floating-point number is represented by a single bit, 8 exponent bits, and 23 significant figure bits. FP 64 may be a floating point format in which a normalized floating-point number is represented by a sign bit, 11 exponent bits, and 52 significant figure bits.

The network speed information of a computing device may be a communication speed between the electronic device 100 and a computing device. For example, a network speed between the electronic device 100 and a first computing device may be 100 Gbps. Additionally, a network speed between the electronic device 100 and a second computing device may be 1 Gbps.

The training method of a computing device may be whether compiling is performed or not at a time of machine learning. That is, the training method of a computing device may be whether a computing device includes a machine learning compiler.

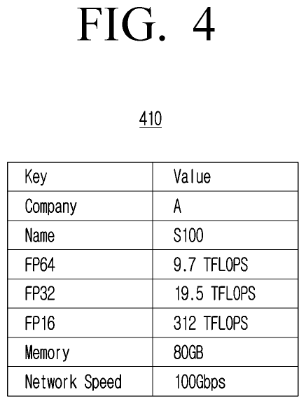

FIG. 4 is a view provided to explain profile information of a computing device according to one or more embodiments.

Referring to FIG. 4, the memory 110 may store profile information 410 of a computing device. At this time, a manufacturer of the computing device may be A. Additionally, a model name of the computing device may be S100. A computation speed of FP64 data of the computing device may be 9.7 Tera floating-point operations per second (TFLOPS). A computation speed of FP32 data of the computing device may be 19.5 TFLOPS. Furthermore, a computation speed of FP16 data of the computing device may be 312 TFLOPS. Additionally, memory capacity of the computing device may be 80 GB. A network speed of the computing device may be 100 Gbps.

Based on profile information of each of multiple computation nodes, the processor 150 may assign a weight to each of the multiple computation nodes (S320). Herein, the weight may be a weight for distributing an AI model and training data at a time when distributed training is performed. Additionally, the weight may be a weight for distributing an AI model at a time when distributed inference is performed.

According to one or more embodiments, the processor 150 may assign a weight to each of multiple computing devices, based a computation speed of multiple computation nodes.

Herein, a computation speed of a computation node may be a computation speed of a computing device constituting a computation node. At this time, the computation speed may be a computation speed of data of bit precision of parameters constituting an AI model.

For example, in the case where bit precision of parameters constituting an AI model is FP64, the processor 150 may assign a weight for distributing an AI model and training data to each of the multiple computing devices, based on a computation speed of FP64 data of the multiple computation nodes.

The processor 150 may assign a weight to each of the multiple computation nodes according to Formula 1 hereunder.

$$Weight of computation node = a * computation speed of computing device constituting computation node * number of computing devices constituting computation nodes . \qquad Formula 1$$

Herein, a may be any real number.

For example, a may be 1, a FP64 data processing speed of a first computing device constituting a first computation node may be 9.7 TFLOPS, and a FP64 data processing speed of a second computing device constituting a second computation node may be 90.5 TFLOPS. Additionally, the first computation node may include two first computing devices, and the second computation node may include three second computing devices. At this time, the processor 150 may assign a weigh of 19.4 to the first computation node, and assign a weight of 271.5 of the second computation node.

A communication speed between the multiple computation nodes and the electronic device 100 may vary depending on each computation node. At this time, in the case where data are distributed to a computation node based on performance information of the computation node, there may be a problem that a speed of distributed training or distributed inference is decreased by a computation node of a slow network speed.

According to one or more embodiments, the processor 150 may assign a weight to each of the multiple computing devices, based on computation speeds of the multiple computation nodes and network speeds of the multiple computation nodes.

The processor 150 may assign a weight to each of the multiple computing devices, based on Formula 2 hereunder.

$$Weight of computation node = ( a * computation speed + b * network speed ) * number of computing devices constituting computation nodes . \qquad Formula 2$$

Herein, a and b may be any real number.

For example, a may be 1, and b may be 0.01. Additionally, a first computation node may include two first computing devices. Computation speeds of the first computing devices may be 9.7 TFLOPS, and network speeds of the first computing devices may be 200 Gbps. A computation speed of a second computing device may be 90.5 TFLOPS, and a network speed of the second computing device may be 100 Gbps. At this time, the processor 150 may assign a weight of 2.6 to the first computing device, and assign a weight of 23.4 to the second computing device.

As described above, as a weight is assigned to a computation node based on performance of the computation node and a network speed of the computation node, data distributed to a computation node of a slow network speed may decrease. Accordingly, a problem such as a decrease in the speed of distributed training or distributed inference caused by a computation node of a slow network speed may be solved.

Meanwhile, as a weight is assigned to each of the multiple computation nodes, the processor 150 may distribute data to the multiple computation nodes, according to the assigned weight (S330). At this time, the data distributed to the multiple computation nodes may be data for performing distributed training by each of the multiple computation nodes. That is, the processor 150 may distribute an AI model and training data for performing distributed training to the multiple computation nodes according to the assigned weight. Alternatively, the processor 150 may distribute an AI model for performing distributed inference to the multiple computation nodes according to the assigned weight.

The processor 150 may distribute data based on a ratio of the weight of each of the multiple computation nodes to a total of the weights assigned to the multiple computation nodes.

For example, at a time of performance of distributed training, in the case where a total of the weights assigned to the multiple computation nodes is 100, while a weight assigned to a first computation node is 2, the processor 150 may distribute 2% of an AI model and 2% of training data to the first computation node.

Meanwhile, a size of data distributed to part of computation nodes based on an assigned weight may be greater than a total of memory capacity of part of the computation nodes. At this time, the total of memory capacity of part of the computation nodes may be a total of memory capacity of computing devices constituting part of the computation nodes. In this case, the processor 150 may adjust a size of data distributed to the multiple computation nodes, so that data corresponding to a total of memory capacity of part of computing devices constituting part of the computation nodes are distributed to part of the computation nodes.

The processor 150 may redistribute, to remaining computation nodes except for part of the computation nodes among the multiple computation nodes, excessive data exceeding the memory capacity of part of the computation nodes, out of the AI model and training data that are distributed to part of the computation nodes based on the assigned weights. At this time, the processor 150 may distribute the data to the multiple computation nodes so that the excessive data may be distributed according to a weight of the remaining computation nodes.

When the data are distributed to the multiple computation nodes, the processor 150 may control the multiple computation nodes to perform distributed training or distributed inference by using the distributed data (S340).

When the training data and AI model are distributed to each of the multiple computing devices, the processor 150 may control the multiple computing devices to train the distributed AI model by using the distributed training data.

Alternatively, when the AI model is distributed to the multiple computing devices, the processor 150 may control the multiple computation nodes to perform distributed inference by using input data and the AI model distributed to the multiple computing devices.

Meanwhile, while distributed training or distributed inference is performed, data may be transceived among the multiple computation nodes. At this time, the data transceived among the multiple computation nodes may be training result data that are acquired as a result of training of a certain layer. Herein, the training result data may be at least one of a gradient that is acquired based on training of a certain layer and a parameter value of a certain layer, but not limited thereto.

For example, the second computation node among the multiple computation nodes may perform distributed training or distributed inference by using data received from the first computation node among the multiple computation nodes.

At this time, a data protocol of each of the computing devices computing the multiple computation nodes may differ. That is, a data protocol of the first computing device constituting the first computation node may differ from a data protocol of the second computing device constituting the second computation node. In this case, there may be a problem that data received from the second computation node are not processible by the first computation node.

A difference between the data protocols of the computation nodes may lead to a difference between data formats processible by the computation nodes. Herein, a data format may be a method or a rule in which data are represented or stored. The data format may be a structure, a layout, an encoding method and the like of data. For example, the data format may be an open format such as JSON, XML, CSV and the like, or a format based on an independently defined standard. At this time, data may be represented in a tensor structure, and depending on a language used, a method of representing a tensor may differ.

To solve the above problem, the electronic device 100 according to the disclosure may convert data output from the first computation node into data processible by each of the multiple computation nodes, transmit the converted data to the second computation node, and control the second computation node such that the second computation node may perform distributed training or distributed inference.

That is, the electronic device 100 according to the disclosure may convert training result data output from one of the multiple computation nodes into a data format based on a universal data protocol processible by each of the multiple computation nodes, to assist with distributed training of a heterogeneous computation node.

The electronic device 100 according to the disclosure may perform distributed training and distributed inference by encoding and decoding data transceived by the multiple computation nodes.

That is, the electronic device 100 according to the disclosure may convert a format of data output from the first computation node into a format of data, which is processible by each of the multiple computation nodes, transmit the converted format of data to the second computation node, and control the second computation node such that the second computation node may perform distributed training or distributed inference by using the received data.

At this time, among the data output from the first computation node, the converted data may be data that are required for the second computation node to perform distributed training or distributed inference.

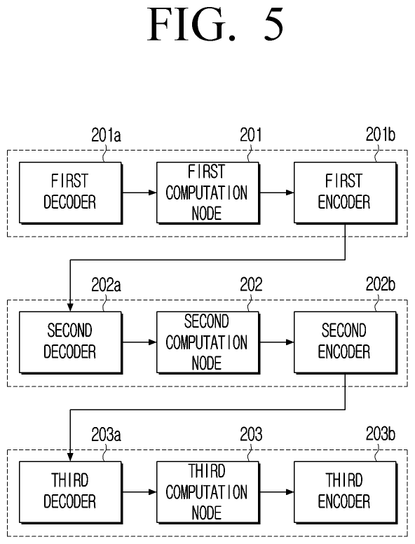

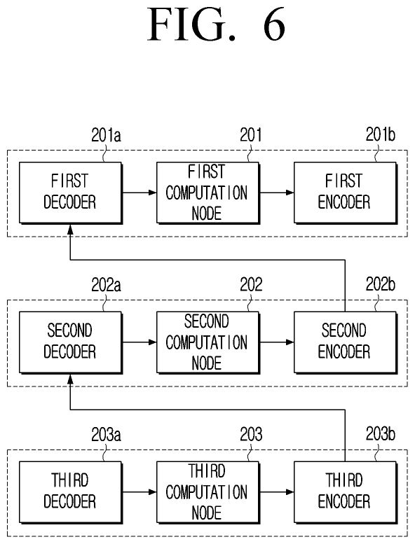

FIG. 5 and FIG. 6 are views provided to explain a method of assisting with data transmission and reception among computation nodes by an electronic device 100 according to one or more embodiments

In FIGS. 5 and 6, at least one layer of an AI model respectively distributed to a first computation node 201, a second computation node 202, and a third computation node 203 may be an adjacent layer among layers constituting the AI model. That is, a n^{th} layer constituting the AI model may be distributed to the first computation node, a n+1^{th} layer constituting the AI model may be distributed to the second computation node, and a n+2^{th} layer constituting the AI model may be distributed to the third computation node. At this time, output data of the n^{th} layer may be input data of the n+1^{th} layer. Additionally, output data of the n+1^{th} layer may be input data of the n+2^{th} layer. Herein, n may be natural numbers greater than or equal to 1.

FIG. 5 is a view provided to explain a flow of data among multiple computation nodes, at a time when distributed training is performed in a direction of forward propagation.

Referring to FIG. 5, the processor 150 may input convert data acquired from a computation node to which a n−1^{th} layer is distributed to a first decoder 201a and convert the same into a data protocol processible by the first computation node 201.

In the case where n is 1, the processor 150 may control the first computation node 201 such that training may be performed by using an AI model and training data distributed to the first computation node 201.

Additionally, the processor 150 may input first data output from the first computation node 201 to a first encoder 201b, and convert a data protocol of the first data into a predefined data protocol. At this time, the first encoder 201b may be an encoder corresponding to the first computation node.

That is, the processor 150 may input the first data output from the first computation node 201 to the first encoder 201b, and convert a data format of the first data into a predefined data format. At this time, the predefined data format may be data of a format processible by each of the multiple computation nodes.

At this time, the first data output from the first computation node 201 may include a training result data value that is acquired by performing training of the Nth layer.

Additionally, the processor 150 may input the first data converted into the predefined data format to a second decoder 202a and convert the data format of the first data into a data format processible by the second computation node 202. Accordingly, the second computation node 202 may perform training of the n+1^{th} layer by using data output by the second decoder 202a.

Additionally, the processor 150 may input second data output from the second computation node 202 to a second encoder 202b and convert a data format of the second data into a predefined data format. At this time, the second encoder 202b may be an encoder corresponding to the second computation node 202.

At this time, the second data output from the second computation node 202 may include a training result data value that is acquired by performing training of the n+1^{th} layer.

Additionally, the processor 150 may input the second data converted into the predefined data format to a third decoder 203a, and convert a data format of the second data into a data format processible by the third computation node 203. Accordingly, the third computation node 203 may perform training of the n+2^{th} layer by using data output by the third decoder 203a.

The processor 150 may input the data output from the third computation node 203 to a third encoder 203b and convert the same to a predefined data format, and input a converted third data to a decoder corresponding to a computation node to which a n+3^{th} layer is distributed. Furthermore, the processor 150 may control the computation node to which the n+3^{th} layer is distributed such that training may be performed by using data output from the decoder.

Meanwhile, in the case where the electronic device 100 performs distributed inference by using the multiple computation nodes, a flow of data among multiple computation nodes may be the same as the flow of data described with reference to FIG. 5.

FIG. 6 is a view provided to explain a flow of data at a time when distributed training is performed in a direction of back propagation.

Referring to FIG. 6, the processor 150 may input at least part of third data output from the third computation node 203 to the third encoder 203b, and convert a data format of the third data into a predefined data format. At this time, the third encoder 203b may be an encoder corresponding to the third computation node 203.

At this time, the third data output from the third computation node 203 may include a training result data value that is acquired by performing training of the n+2^{th} layer. Herein, training result data may include at least one of a gradient and a parameter value acquired by performing training of the n+2^{th} layer.

Additionally, the processor 150 may input the third data converted into the predefined data format to the second decoder 202a and convert the data format of the third data into a data format processible by the second computation node 202. Accordingly, the second computation node 202 may perform training of the n+1^{th} layer by using data output by the second decoder 202a.

The processor 150 may input second data output from the second communication node 202 to the second encoder 202b and convert a data format of the second data into a predefined data format. At this time, the second encoder 202b may be an encoder corresponding to the second computation node 202.

At this time, the second data output from the second communication node 202 may include a training result data value that is acquired by performing training of the n+1^{th} layer. Herein, training result data may include at least one of a gradient and a parameter value acquired by performing training of the n+1^{th} layer.

Furthermore, the processor 150 may input the second data converted into the predefined data format to the first decoder 201a, and convert the data format of the second data into a data format processible by the first computation node 201. Accordingly, the first computation node 201 may perform training of the n^{th} layer by using data output by the first decoder 201a.

Meanwhile, when converting data output from a certain computation node into a predefined data format, the processor 150 may add information on an epoch that is a training unit and information on time to the data output from the certain computation node.

That is, the processor 150 may identify training performance time of each of the multiple computation nodes from the information on an epoch and the information on time that are added to the output data.

That is, the processor 150 may identify training performance time of each epoch of each of the multiple computation nodes from results of training performed by each of the multiple computation nodes.

Accordingly, the processor 150 may adjust data distributed to each of the multiple computation nodes as an epoch as part of distributed training is performed.

The processor 150 may reduce data distributed to a computation node of which training performance time is greater than or equal to a threshold value among the multiple computation nodes. Herein, the threshold value may be greater than or equal to a preset value than an average of training performance time of the multiple computation nodes. Alternatively, the threshold value may be a value outside a preset range in distribution of training performance time of the multiple computation nodes. Alternatively, the threshold value may be the longest time out of training performance time of the multiple computation nodes.

For example, regarding a first epoch, in the case where an average of performance time of the multiple computation nodes is three seconds, while a preset value is two seconds, the processor 150 may reduce data distributed to a computation node of which training performance time is greater than or equal to five seconds. At this time, the processor 150 may adjust the data distributed to the computation node of which training performance time is greater than or equal to five seconds such that the data may be included in another computation node. The processor 150 may control the multiple computation nodes to perform training according to a second epoch, based on the redistributed data.

Meanwhile, the electronic device 100 according to the disclosure may acquire a user input setting a computation node to perform distributed training from the user, and perform distributed training by using the computation node set based on the user input.

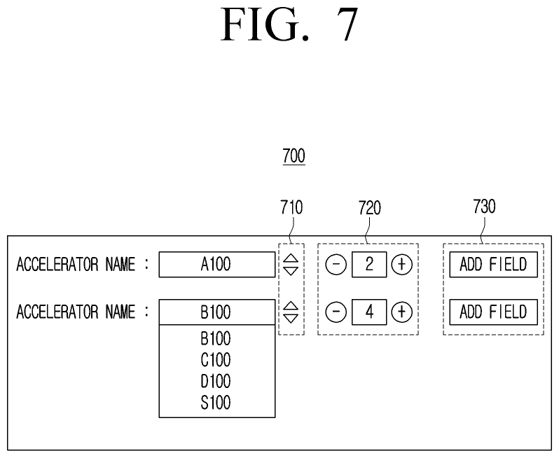

FIG. 7 is a view provided to explain a method of providing a UI setting a computation node according to one or more embodiments.

Referring to FIG. 7, the processor 150 may provide, to the user, a UI 700 for setting multiple computation nodes capable of performing distributed training. At this time, the processor 150 may control a display 130 to display the UI 700. Alternatively, the processor 150 may transmit information for displaying the UI 700 to a user terminal device.

At this time, the user may set a computing device constituting a computation node through an UI element 710 for selecting a computing device constituting a computation node.

At this time, in the case where at least one computing device is selected, the processor 150 may display computing devices in the way that a computing device that can perform distributed training together with the at least one selected computing device is distinguished from a computing device that cannot perform distributed training together with the at least one selected computing device.

Herein, in the case where at least one selected computing device does not assist with machine learning compiling, the computing device that can perform distributed training together with the at least one selected computing device may be a computing device that does not assist with machine learning compiling. For example, A100, B100 and C100 may be devices that assist with machine learning compiling, and D100 and S100 may be devices that do not assist with machine learning compiling.

Additionally, in the case where the at least one selected computing device does not assist with machine learning compiling, the computing device that cannot perform distributed training together with the at least one selected computing device may be a computing device that assists with machine learning compiling.

Alternatively, in the case where the at least one selected computing device assists with machine learning compiling, the computing device that can perform distributed training together with the at least one selected computing device may be a computing device that assists with machine learning compiling. Additionally, in the case where the at least one selected computing device assists with machine learning compiling, the computing device that cannot perform distributed training together with the at least one selected computing device may be a computing device that does not assist with machine learning compiling.

The user may select a number of computing devices constituting computation nodes through the UI element 720 for selecting a number of computing devices constituting each of computation nodes. Furthermore, the user may add a computation node for performing distributed training or distributed inference through the UI element 730 for adding a computation node.

As described above, in the case where a computation node for performing distributed training is set, the processor 150 may perform distributed training by using the set computation node.

Meanwhile, the term “unit” or “module” set forth herein may include a unit comprised of hardware, software or firmware, and for example, may be used interchangeably with terms such as logic, a logic block, a component or a circuit and the like. The term “unit” or “module” may be an integrally constituted component or a minimum unit performing one or more functions or part thereof. For example, the module may be comprised of an application-specific integrated circuit (ASIC).

The embodiments according to the disclosure may be implemented with software including instructions stored in a storage medium readable by a machine (e.g., a computer). The machine, as a device capable of calling the stored instructions from the storage media and operating according to the called instructions, may include an electronic device 100 according to the disclosed embodiments. When the instructions are executed by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. Herein, the term “non-transitory” means that the storage medium includes no signal and is tangible, while the term does distinguish semi-permanent or temporary storage of data in the storage medium.

According to one or more embodiments, the method according to the embodiments set forth herein may be provided in a computer program product. The computer program product may be exchanged between a seller and a purchaser as a commodity. The computer program product may be distributed in the form of a machine-readable storage medium (e.g., compact disc read only memory (CD-ROM)), or distributed online through an application store (e.g., Play Store™). In the case of online distribution, at least part of the computer program product may be stored at least temporarily, or generated temporarily in a storage medium such as a server of a manufacturer, a server of an application store, or memory of a relay server.

Each of the elements (e.g., a module or a program) according to the embodiments may be comprised of a single entity or multiple entities, and some of the corresponding sub elements described above may be omitted, or another sub element may be further included in the embodiments. Alternatively or additionally, some of the elements (e.g., modules or programs) may be integrated into one entity to perform functions performed by each corresponding element prior to the integration in an identical or similar way. Operations performed by a module, a program, or another element, according to the embodiments, may be executed consecutively, in parallel, repetitively, or heuristically, or at least part of the operations may be executed in a different order, may be omitted, or may add a different operation.

What is claimed is:

1. An electronic device performing distributed training of an artificial intelligence (AI) model in a heterogeneous computing environment, the electronic device comprising:
a communication interface configured to perform communication with multiple computation nodes;
a memory configured to store profile information on the multiple computation nodes and at least one instruction; and
at least one processor configured to execute the at least one instruction to:
assign a weight to each of the multiple computation nodes for segmenting the AI model and training data, based on the profile information;
distribute the segmented AI model and the segmented training data to the multiple computation nodes based on the assigned weight;
control the multiple computation nodes to train the segmented AI model based on the segmented training data;
convert training result data received from a first computation node among the multiple computation nodes into a data format processible by each of the multiple computation nodes; and
control a second computation node among the multiple computation nodes to train the segmented AI model based on the converted data.

2. The electronic device as claimed in claim 1, wherein the at least one processor is further configured to execute the at least one instruction to:
convert the training result data received from the first computation node into a predefined data format, and
convert the predefined data format into the data format processible by the second computation node.

3. The electronic device as claimed in claim 1,
wherein the profile information includes performance information and network speed information of the multiple computation nodes, and
wherein the at least one processor is further configured to execute the at least one instruction to assign a weight for distributing the segmented AI model and the segmented training data to each of the multiple computation nodes, based on the performance information and the network speed information.

4. The electronic device as claimed in claim 1, wherein the at least one processor is further configured to execute the at least one instruction to distribute the segmented AI model and the segmented training data to the multiple computation nodes, based on a ratio of a weight assigned to each of the multiple computation nodes to a total of weights assigned to the multiple computation nodes.

5. The electronic device as claimed in claim 1,
wherein the at least one processor is further configured to execute the at least one instruction to:
based on a size of the segmented AI model and segmented training data, that are distributed to at least one computation node among the multiple computation nodes, exceeding memory capacity of the at least one computation node,
redistribute at least a portion of the segmented AI model and the segmented training data that are distributed to the at least one computation node to one or more other computation nodes among the multiple computation nodes based on the memory capacity of the at least one computation node.

6. The electronic device as claimed in claim 1, wherein the at least one processor is further configured to execute the at least one instruction to:
identify a computation time taken for each of the multiple computation nodes to train the segmented AI model, and
adjust sizes of the segmented AI model and the segmented training data that are distributed, based on the computation time.

7. The electronic device as claimed in claim 1, wherein the at least one processor is further configured to execute the at least one instruction to:
acquire a user input for selecting a computation node for performing the distributed training among the multiple computation nodes, and
perform distributed training of the AI model based on the selected computation node.

8. The electronic device as claimed in claim 1, wherein the at least one processor is further configured to execute the at least one instruction to:
identify training performance time of the multiple computation nodes,
identify a computation node having the training performance time greater than or equal to a threshold value among the multiple computation nodes, and
reduce the segmented training data that is distributed to the computation node.

9. A control method of an electronic device performing distributed training of an artificial intelligence (AI) model in a heterogeneous computing environment, the method comprising:
assigning a weight to each of multiple computation nodes for segmenting the AI model and training data, based on profile information of each of the multiple computation nodes;
distributing the segmented AI model and the segmented training data to the multiple computation nodes based on the assigned weight;
controlling the multiple computation nodes to train the segmented AI model based on the segmented training data;
converting training result data received from a first computation node among the multiple computation nodes into a data format processible by each of the multiple computation nodes; and
controlling a second computation node among the multiple computation nodes to train the segmented AI model based on the converted data.

10. The control method of claim 9, the method further comprising:
converting the training result data received from the first computation node into a predefined data format, and
converting the predefined data format into the data format processible by the second computation node.

11. The control method of claim 9,
wherein the profile information includes performance information and network speed information of the multiple computation nodes, and
wherein the assigning a weight comprises:
assigning a weight for distributing the segmented AI model and the segmented training data to each of the multiple computation nodes, based on the performance information and the network speed information.

12. The control method of claim 9,
wherein the distributing the segmented AI model and the segmented training data to the multiple computation nodes comprises:
distributing the segmented AI model and the segmented training data to the multiple computation nodes, based on a ratio of a weight assigned to each of the multiple computation nodes to a total of weights assigned to the multiple computation nodes.

13. The control method of claim 9,
wherein the distributing the segmented AI model and the segmented training data to the multiple computation nodes comprises:
based on a size of the segmented AI model and segmented training data, that are distributed to at least one computation node among the multiple computation nodes, exceeding memory capacity of the at least one computation node,
redistributing at least a portion of the segmented AI model and the segmented training data that are distributed to the at least one computation node to one or more other computation nodes among the multiple computation nodes based on the memory capacity of the at least one computation node.

14. The control method of claim 9, the method further comprising:
identifying a computation time taken for each of the multiple computation nodes to train the segmented AI model, and
adjusting sizes of the segmented AI model and the segmented training data that are distributed, based on the computation time.

15. The control method of claim 9, the method further comprising:
acquiring a user input for selecting a computation node for performing the distributed training among the multiple computation nodes, and
performing distributed training of the AI model based on the selected computation node.
